(19) United States
(12) Patent Application Publication
(10) Pub. No.: US 2023/0397639 A1
(43) Pub. Date: Dec. 14, 2023

(54) DEVICE FOR FORMING FRUIT AND VEGETABLES

(71) Applicant: FRAUNHOFER-GESELLSCHAFT ZUR FÖRDERUNG DER ANGEWANDTEN FORSCHUNG E. V., München (DE)

(72) Inventors: Christian Kaiser, Valley (DE); Severin Seifert, Valley (DE); Christine Kalina, Valley (DE); Sebastian Dittrich, Valley (DE)

(21) Appl. No.: 18/033,869

(22) PCT Filed: Oct. 26, 2021
(86) PCT No.: PCT/EP2021/079596

§ 371 Date: Apr. 26, 2023

(30) Foreign Application Priority Data
Oct. 28, 2020 (DE) 102020128303.2

(51) Int. Cl. A23L 19/00

(52) U.S. Cl. CPC A23L 19/05

(57) ABSTRACT

The present invention relates to a method for forming fruit and vegetables by means of ultrasonic waves, to a convenience food item comprising fruit and vegetables formed in this way, and to the use of ultrasonic waves for forming fruit and vegetables.

The present invention relates to a method for forming fruit and vegetables by means of ultrasonic waves, to a convenience food item comprising fruit and vegetables formed in this way, and to the use of ultrasonic waves for forming fruit and vegetables.

### TECHNICAL BACKGROUND

Within the field of foodstuffs, cucurbits are part of the everyday usage, since they vary widely in flavor and, moreover, function also in combination with other ingredients in the context, for example, of a “filled” preparation. A high nutrient content and also a high water fraction, as well as the local availability, are further advantages united in this variety of vegetable.

Driven by societal change in relation to foodstuffs, the eye of the processing industry as well, first and foremost the convenience product and “fast food” industry, has been drawn to these “superfoods”. The branch of industry, however, is heavily reliant on standardization and simplification. For fast food restaurants, parameters such as quick preparation, rapid servability, and quick consumption are vital. In the case of cucumbers, for example, this means that they would have to be standardized in their shape. Moreover, they need to be excavated in order for the flavor offering to be expanded with fillings. While solutions have been found for the external shaping, through a growth process in a defined glass vessel, for example, or, indeed, by the removal of the peel, a problem is nevertheless still presented by their excavation. Not necessarily in its execution or because of the fraction of seeds (cultivation of seedless cucumbers), but in the production of residual substances. The reason is that the hollowing process removes large parts of the pulp. Furthermore, according to the German Federal Nutrition Center, cucumbers are among the hard-to-digest varieties with bloating effect. The latter may be diminished, for example, by a cooking process. However, these intermediate steps again impact the preparation time.

Progress would be achieved, accordingly, if it were possible to combine a food preparation process (cooking) directly with the excavation and/or the removal of the peel from fruit or vegetables, but while producing a minimum of residual substances.

From the prior art, such as DE 10 2014 112 083 A1, EP 1 867 236 A2, U.S. Pat. Nos. 3,382,900, 7,096,777 B1 or WO 03043443, for example, there are automated mechanical methods known for the forming and excavation of particular fruit and vegetable varieties. These methods, however, have the disadvantage that, to start with, because of the method of mechanical scraping, the resulting pulp scraped out must either be used again or disposed of, thereby giving rise to additional costs in the production operation. Furthermore, the mechanical devices presented in the prior art lack great flexibility, which imposes tight shape requirements on the fruit and vegetables in order for a satisfactory result to be achieved. This leads to a large quantity of discard from fruit and vegetables which in principle is edible, but which fails to meet the tightly imposed shape requirements as a result only, for example, of curvature, length or thickness. In addition, the methods from the prior art serve only for forming fruit and vegetables. The fruit and vegetables thus formed have to be rendered consumable in further steps, by cooking, for example.

The present invention is based on the object of overcoming the disadvantages set out above. It has surprisingly been determined that by means of sonochemistry—that is, acoustic cavitation by ultrasonic waves—it is possible to form fruit and vegetables without substantial production of residual substances, independently of shape prescriptions, and at the same time to render them consumable by a kind of microcooking.

### SUMMARY OF THE INVENTION

The present invention relates to a method for forming fruit and vegetables, comprising the following method steps:
a) providing a piece of fruit or vegetable;
b) irradiating the piece of fruit or vegetable with ultrasonic waves;
c) heating the liquid in the pulp of the piece of fruit or vegetable by acoustic cavitation;
d) disrupting the cell structures of the pulp by liquid evaporation;
e) forming a cavity in the piece of fruit or vegetable.

In a further aspect, the present invention relates to a convenience food item comprising one or more pieces of fruit or vegetable formed with the method as described herein.

In an additional aspect, the present invention relates to the use of sound waves for forming fruit or vegetables.

### DETAILED DESCRIPTION OF THE INVENTION

The present invention relates to a method for forming fruit and vegetables, comprising the following method steps:
a) providing a piece of fruit or vegetable;
b) irradiating the piece of fruit or vegetable with ultrasonic waves;
c) heating the liquid in the pulp of the piece of fruit or vegetable by acoustic cavitation;
d) disrupting the cell structures of the pulp by liquid evaporation;
e) forming a cavity in the piece of fruit or vegetable.

The method is suitable for any fruit or vegetables which because of a firm pulp are suitable for being formed by peeling and excavation. Particularly suitable are cucurbits (Cucurbitaceae), such as pumpkins, melons, cucumbers, and zucchini, especially cucumbers and zucchini.

The ultrasonic waves are generated preferably in an ultrasound processor. Such ultrasound processors are known in the prior art in connection, for example, with ultrasonic manufacturing processes such as ultrasonic welding or ultrasonic vibration lapping, and require no further modifications for the method of the invention.

The ultrasound is transmitted to the piece of fruit or vegetable preferably by way of a sonotrode. This sonotrode is typically the sole component of an ultrasound processor that is in direct contact with the piece of fruit or vegetable. The sonotrode is preferably immersed into the pulp of the piece of fruit or vegetable. In this procedure, the liquid in the pulp is heated by acoustic cavitation.

Cavitation is understood to refer to the formation of bubbles and their oscillation under the influence of high-frequency fluctuations in pressure and/or density within liquids. Nonelastic behavior on the part of media leads to the rupturing of the continuous fluid phase and to the formation of bubbles. Inhomogeneities present within the fluid promote the cavitation. After the bubbles have developed, vapor from the surrounding liquid or gases dissolved in the liquid diffuse successively into the bubble. In the case of “vapor cavitation” (hardtransient cavitation), the bubbles implode after just a few oscillations, with local release of high energy intensities. Where the cavitation is caused by sound waves, such as ultrasonic waves, it is referred to as acoustic cavitation.

The sonotrode is preferably adjustably mounted. The adjustably mounted sonotrode can be adapted to the individual shape of the piece of fruit or vegetable by positional adjustment in at least one dimension, preferably in all three dimensions, and/or by adjustment of the angle.

The method, accordingly, is suitable firstly for different kinds of fruit and vegetable having different general shapes, such as, for example, salad cucumbers and watermelons, and also, within one variety of fruit or vegetable, for pieces of fruit or vegetable that deviate from the customary norm in terms of curvature, length or thickness, for example.

As a result of the fluctuations in pressure and density of the ultrasonic waves during the acoustic cavitation, the liquid in the pulp, customarily in the immediate vicinity of the immersed sonotrode, heats up. As a result of the heating, the pulp is preferably microcooked, i.e., cooked by means of heating through the ultrasonic waves.

The excavating and cooking steps may also be separated temporally and/or spatially. Thus, for example, the piece of fruit or vegetable may be excavated in a first step as described herein. The excavated piece of fruit or vegetable may then be cooked in a second step with the aid of ultrasonic waves. Prior to the cooking, the excavated piece of fruit or vegetable may be filled with a food, such as a cheese preparation or a meat preparation, such as a minced meat preparation, for example. This food may then likewise be heated and, optionally, microcooked during the heating of the liquid in the pulp.

The cooking process makes the piece of fruit or vegetable, especially cucurbits, more digestible. As a result it is possible to forgo a further cooking process during the production of a convenience food item. With the aid of the method of the invention, accordingly, a food item can thus be produced that is already edible.

The ultrasonic waves preferably have a frequency of 20 to 2000 kHz. The liquid in the pulp may be exposed locally to temperatures of up to 5000 K. Furthermore, the liquid in the pulp may be exposed locally to pressures of up to 1000 bar. Still further, the liquid in the pulp may be exposed locally to a flow rate of up to 400 kmh. The heating may be accompanied in certain locations by temperature jumps of up to 110 K/s. The conditions obtained here are customarily dependent on the frequency of the ultrasonic waves.

Given appropriate duration of exposure to the ultrasonic waves, the liquid in the pulp typically heats up to an extent such that it evaporates, causing the cell structures of the pulp to be disrupted. The pulp thus disrupted hence loses its cellular stability and, preferably by the impulse of the ultrasonic waves, is pressed against the side walls of the piece of fruit or vegetable. This produces a cavity in the piece of fruit or vegetable.

The side walls, which are unaffected by the ultrasonic waves, are preferably compacted and reinforced by the pulp pressed against them, and so form a stable vessel structure suitable for filling, for example, with suitable foods, such as, for example, compotes, chutneys, cheese preparations, meat preparations, cut-up or ground fruit or vegetables, or mixtures thereof.

Additionally to cavities in the piece of fruit or vegetable, the methods described herein may also be used to partially or entirely remove the skin or peel of the piece of fruit or vegetable.

The method described herein may also be used to form patterns or multidimensional structures in a piece of fruit or vegetable.

In a further aspect, the present invention relates to a convenience food item comprising one or more pieces of fruit or vegetable formed with the method as described herein.

The convenience food item preferably comprises the piece of fruit or vegetable, formed with the method described herein, that is preferably filled with one or more further foods, such as, for example, compotes, chutneys, cheese preparations, meat preparations, cut-up or ground fruit or vegetables, or mixtures thereof.

The convenience food item may be a food item for the end consumer market or for the restaurant trade.

The food item for the end consumer market is preferably a ready meal, typically from the consumer market, which is either preparation-ready or ready to be consumed already.

The food item for the restaurant trade is preferably a meal or part of a meal in a fast food restaurant.

The convenience food item of the invention has the following advantages for the market:
As a result of the method of the invention, there are fewer residual or waste substances, since the pulp, rather than being cut out, is pressed against the side walls of the piece of fruit or vegetable.
The stabilization of the side walls of the formed piece of fruit or vegetable produces a stable vessel for fillings. This opens up the market for filled fruit or vegetables by means of fruit or vegetable varieties which have to date been considered unsuitable for filling because of their deficient stability.
With the method of the invention, it is possible to process fruit and vegetables having different shapes and sizes. Hence there is less discarding of generally consumable fruit and vegetable.
With the method of the invention, fruit and vegetables can be formed and cooked in one process. Hence a further preparation step is saved and the market is opened for fruit and vegetable varieties which are relatively indigestible raw.
Through the microcooking method with the aid of the sound waves, it is also possible to a certain degree to control the flavor of the convenience food item of the invention. Because of the acoustic cavitation, chemical breakdown processes can be initiated in the piece of fruit or vegetable or, possibly, in the filling exposed to the ultrasonic waves, these processes possibly influencing the flavor. Moreover, there are no alterations in flavor anticipated through pyrolysis, as in the case of other heating techniques such as boiling, frying or deep-frying.
The heat input and therefore the cooking process may also be controlled in a locally targeted way through the sonotrode.
The method of the invention can also be used to form chilled or deep-frozen fruit or vegetables and at the same time to bring them to a desired consumption temperature. It is therefore possible to forgo an additional heating step.
With the method of the invention, therefore, convenience food items can be produced in a simple, standardized and hence cost-effective process without excessive wastes and with few process steps, as required by the fast food industry.

In an additional aspect, the present invention relates to the use of sound waves for forming fruit or vegetables.

The sound waves thereby are used preferably according to all of the aspects and embodiments as described herein for the method of the invention.

### EXAMPLE

The method of the invention for forming fruit and vegetables is depicted illustratively in the text below, with reference to the excavation of a salad cucumber:

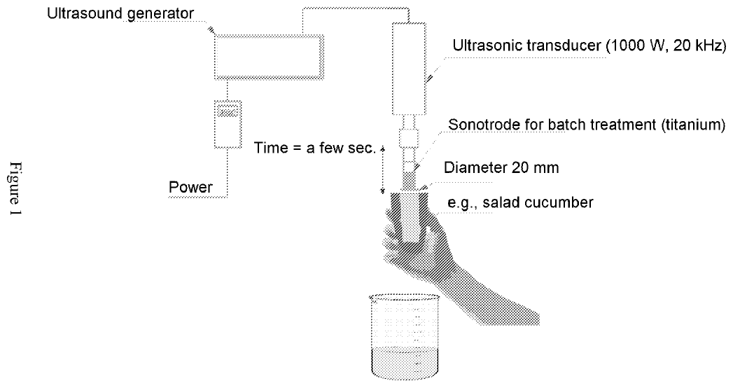

The test setup is represented schematically in FIG. 1:

For the treatment of a salad cucumber, a titanium sonotrode having a diameter of 20 mm was used. For other forms of fruit and vegetable, the sonotrode may be replaced by other sonotrodes having a larger or smaller diameter.

The sonotrode is connected to an ultrasound apparatus comprising an ultrasound generator and an ultrasonic transducer, operated with a power of 1000 W at 20 kHz. The power may likewise be adapted individually to the piece of fruit or vegetable to be formed.

The salad cucumber is contacted with the sonotrode for a few seconds, during which it is guided upward along the sonotrode. In addition, depending on the shape of the piece of fruit or vegetable, other movements along the sonotrode are also possible, such as lateral or circular movements, for example.

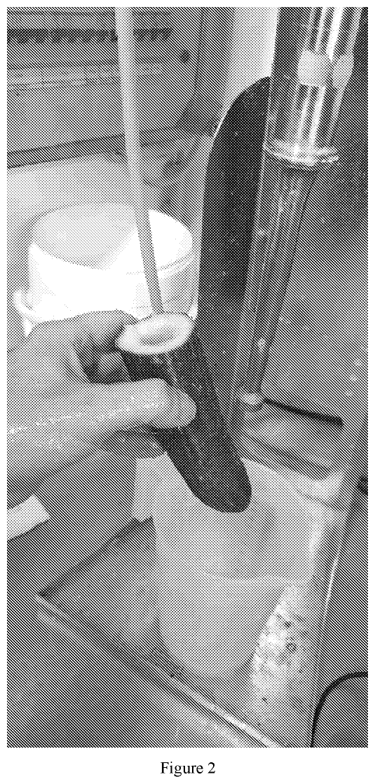

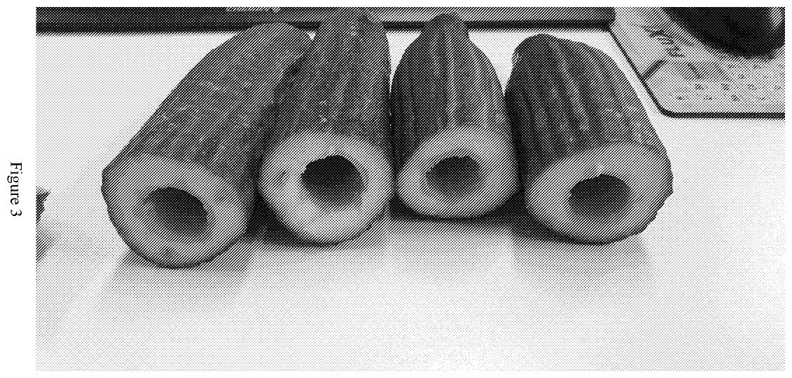

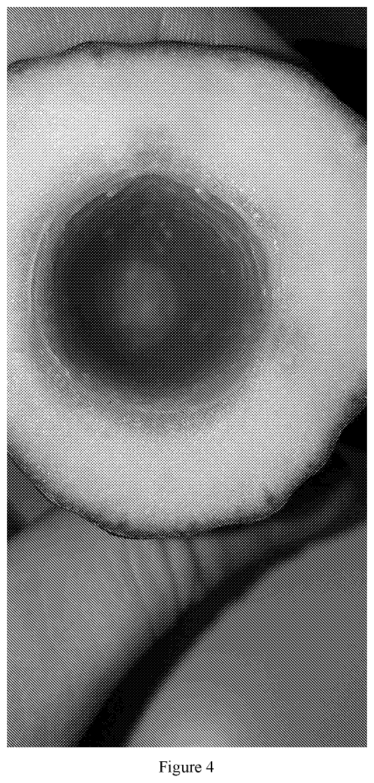

The ultrasound generates a cylindrical hole in the salad cucumber, as shown in FIGS. 2-4, without affecting the surrounding tissue of the salad cucumber.

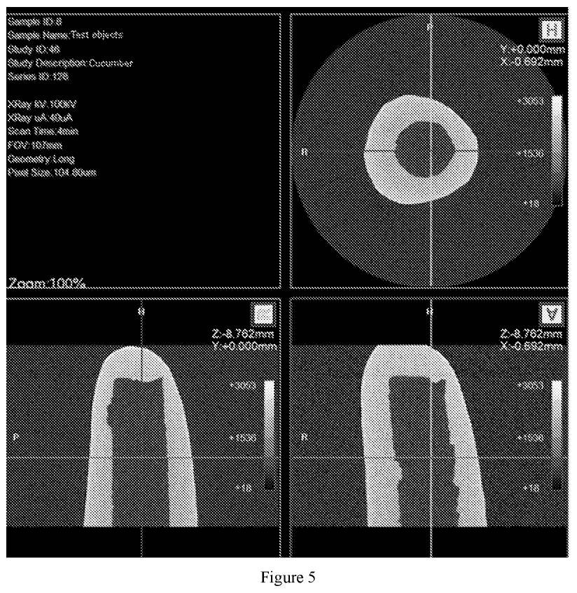

In FIGS. 5-7, x-ray tomography pictures show the smooth faces of the cylindrical hole without adverse effect on the surrounding tissue. Specifically it can be seen in

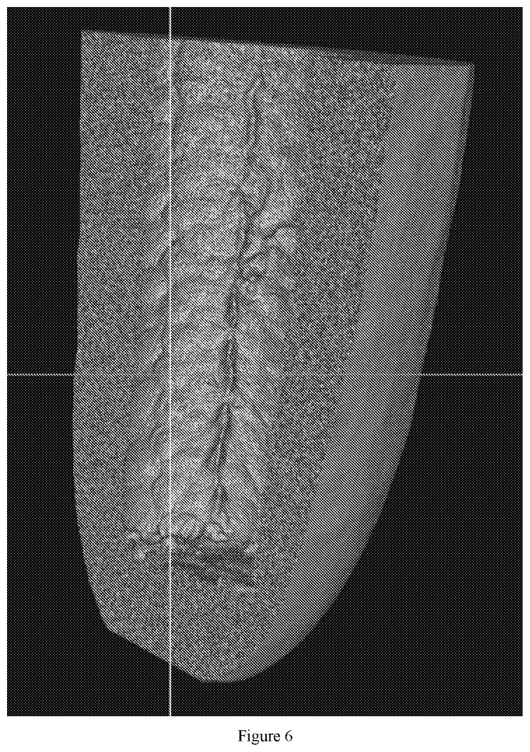

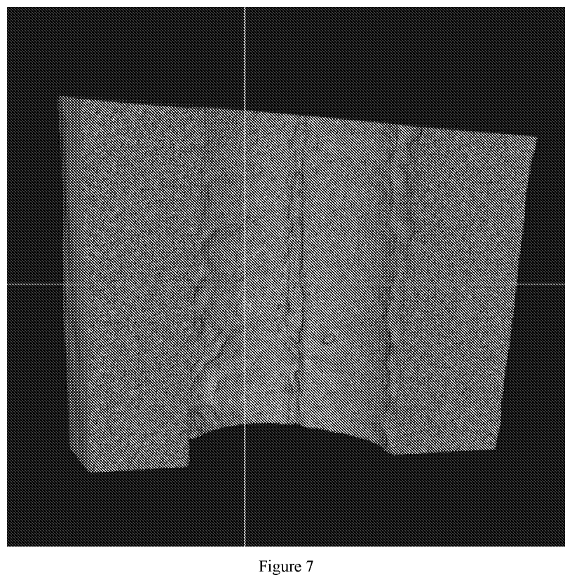

FIGS. 6 and 7 that the pulp is pressed against the side walls of the resultant cylindrical hole.

During the shaping, there is no further waste apart from the tissue liquid emerging from the seed zone or cavity zone.

1. A method for forming fruit and vegetables, comprising the following method steps:
a) providing a piece of fruit or vegetable;
b) irradiating the piece of fruit or vegetable with ultrasonic waves;
c) heating the liquid in the pulp of the piece of fruit or vegetable by acoustic cavitation;
d) disrupting the cell structures of the pulp by liquid evaporation;
e) forming a cavity in the piece of fruit or vegetable.

2. The method as claimed in claim 1, wherein the piece of fruit or vegetable is irradiated with ultrasonic waves by means of a sonotrode, preferably by means of an adjustably mounted sonotrode.

3. The method as claimed in claim 1, wherein the ultrasonic waves have a frequency in the range from 20 to 2000 kHz.

4. The method as claimed in claim 1, wherein the liquid in the pulp during the heating by acoustic cavitation is exposed locally to a temperature of up to 5000 K and/or a pressure of up to 1000 bar and/or a flow rate of up to 400 kmh.

5. The method as claimed in claim 1, wherein during the heating of the liquid, the pulp is microcooked.

6. The method as claimed in claim 1, wherein the forming of the cavity in the piece of fruit or vegetable involves pressing the disrupted cell structures of the pulp to the side.

7. The method as claimed in claim 1, wherein the excavated piece of fruit or vegetable is filled with foods and thereafter irradiated with ultrasonic waves and during the heating of the liquid this filling is cooked too.

8. The method as claimed in claim 1, wherein the skin or peel of the piece of fruit or vegetable is removed partially or entirely by acoustic cavitation.

9. The method as claimed in claim 1, wherein the cavities form patterns or multidimensional structures in the piece of fruit or vegetable.

10. The method as claimed in claim 1, wherein the piece of fruit or vegetable is selected from cucurbits, preferably pumpkins, melons, cucumbers, and zucchini.

11. A convenience food item comprising one or more pieces of fruit or vegetable formed with the method as claimed in claim 1.

12. The method of forming fruit or vegetables by sound waves.
